(19) United States
(12) Patent Application Publication
(10) Pub. No.: US 2024/0010234 A1
(43) Pub. Date: Jan. 11, 2024

(54) APPARATUS AND METHOD FOR CONTROLLING A VEHICLE

(71) Applicant: JAGUAR LAND ROVER LIMITED, Whitley, Coventry, Warwickshire (GB)

(72) Inventors: Juan HERRERA, Whitley, Coventry, Warwickshire (GB); Maxime PENET, Whitley, Coventry, Warwickshire (GB)

(21) Appl. No.: 18/044,767

(22) PCT Filed: Sep. 9, 2021
(86) PCT No.: PCT/EP2021/074843

§ 371 Date: Mar. 9, 2023

(30) Foreign Application Priority Data
Sep. 9, 2020 (GB) 2014147.9

(51) Int. Cl. B60W 60/00; B60W 30/09; B60W 30/095; B60W 50/00

(52) U.S. Cl. CPC B60W 60/0015; B60W 30/09; B60W 30/0956; B60W 50/00; B60W 2050/0028; B60W 2554/402; B60W 2554/4041; B60W 2554/4044; B60W 2554/80

(57) ABSTRACT

The disclosure relates to a control system comprising controllers, the control system comprising input means configured to receive object data indicative of objects in a vicinity of a vehicle and state data indicative of a state of the vehicle, memory means configured to store data indicative of a model associated with the vehicle, processing means arranged to determine one or more a control input for the vehicle, wherein determining the control input comprises the processing means obtaining trajectory data indicative of a desired trajectory for the vehicle, determining a constraint for a solution of a control algorithm for the vehicle, wherein the constraint is representative of one or more of the objects in the vicinity of the vehicle and the constraint is determined based on an attribute of each of the one or more objects, and determining the control input for the vehicle based on the solution of the control algorithm.

### TECHNICAL FIELD

The present disclosure relates to apparatus and methods and particularly, but not exclusively, to apparatus and methods for controlling a vehicle. Aspects of the invention relate to a method, to a controller, to a system, to a vehicle and to computer software.

### BACKGROUND

It is increasingly desired to, at least partly, autonomously control vehicles. Different aspects of a vehicle may be autonomously controlled, such as a speed of the vehicle and a steering of the vehicle. The vehicle may be controlled to achieve a desired state from a current state of the vehicle. The current and desired states may be defined by one or more parameters of the vehicle such as a heading and a position of the vehicle. Some control schemes are only reactive to a measured state of the process such as Proportional-Integral-Derivative (PID) control schemes. Pre-emptive control schemes are also known such as Model Predictive Control (MPC) which aim to achieve the desired state of the vehicle based on a current state of the vehicle by predicting one or more future states of the vehicle. MPC control is based on a model of the vehicle under control and information about the current state of the vehicle. It is desired for the autonomous control of the vehicle to be reactive to objects in a vicinity of the vehicle. Such objects can include non-moving objects such as structures or surface markings, and also moveable or dynamic objects such as other vehicles and people. It is an object of embodiments of the invention to at least mitigate one or more of the problems of the prior art.

### SUMMARY OF THE INVENTION

Aspects and embodiments of the invention provide an control system, a system, a vehicle, a method and computer software as claimed in the appended claims.

According to an aspect of the present invention there is provided a control system comprising one or more controllers, the control system comprising processing means arranged to determine one or more control input for the vehicle, wherein the determining of the one or more control input comprises the processing means obtaining trajectory data indicative of a desired trajectory for the vehicle, determining a constraint for a solution of a control algorithm for the vehicle, wherein the constraint is representative of one or more objects in a vicinity of the vehicle, and determining the control inputs for the vehicle in dependence on the solution of the control algorithm for the vehicle. Advantageously, the control inputs for the vehicle are determined in dependence on the objects in the vicinity of the vehicle.

According to an aspect of the present invention there is provided a control system comprising one or more controllers, the control system comprising input means configured to receive object data indicative of one or more objects in a vicinity of a vehicle and state data indicative of a state of the vehicle, memory means configured to store data indicative of a model associated with the vehicle, processing means arranged to determine one or more control input for the vehicle, wherein determining one of the one or more control input comprises the processing means obtaining trajectory data indicative of a desired trajectory for the vehicle, determining a constraint for a solution of a control algorithm for the vehicle, wherein the constraint is representative of one or more of the objects in the vicinity of the vehicle and the constraint is determined in dependence on an attribute of each of the one or more objects, and determining the control inputs for the vehicle in dependence on the solution of the control algorithm for the vehicle, wherein the control algorithm comprises the model associated with the vehicle, the state data, the trajectory data and the constraint, and wherein the system comprises output means arranged to output a signal indicative of the one or more control input for controlling the vehicle. Advantageously, the control inputs for the vehicle are determined in dependence on the objects in the vicinity of the vehicle.

The control system as described above, wherein, the input means may comprise an electrical input, the memory means may comprise one or more memory devices, the output means may comprise an electric output, and the processing means may comprise one or more electronic processing devices.

The one or more constraints may vary in dependence on the one or more attributes of the one or more objects represented by the constraint. Advantageously, the control inputs are determined in dependence on the one or more attributes of the one or more objects.

The processing means may be arranged to determine each of the one or more constraints as a risk value indicative of a risk associated with a proximity of the vehicle to the one or more objects. Advantageously, the control inputs are determined in dependence on the associated risk. The risk value is optionally determined to vary in value up to a predetermined maximum value (e.g. 1) in dependence on the one or more attributes. Advantageously, the risk value is determined up to the predetermined maximum.

The processing means may be arranged to determine each constraint in dependence on a function of the one or more attributes of the one or more objects represented by the constraint. Advantageously, the control inputs are determined in dependence on the one or more attributes. The function may be representative of an intervention area peripheral to the one or more objects represented by the constraint. The function may be representative of a critical area of the one or more objects represented by the constraint. The function may be a bump function. Advantageously the intervention area may represent an area where the control inputs may intervene with respect to the object. Advantageously the critical area may represent an area where the control inputs may intervene at a critical level of importance with respect to the object.

Optionally, one or both of the intervention area and the critical area are determined in dependence on the one or more attributes of the one or more objects. Advantageously one or both of the intervention area and the critical area may account for the one or more attributes.

The processing means may be arranged to determine the solution of the control algorithm for the vehicle in dependence on the one or more constraints and a predetermined risk threshold. Advantageously the risk threshold may represent a threshold at which the control inputs are controlled. The processing means may be arranged to determine the solution of the control algorithm for the vehicle such that one or more constraints adopt a risk value less than the predetermined risk threshold. Advantageously the one or more constraints may be determined as being below the risk threshold.

The object data is optionally indicative of the one or more attributes of each of the one or more objects in the vicinity of the vehicle. Advantageously the attributes are represented in the object data. The processing means may be arranged to select at least some of the objects in the vicinity of the vehicle in dependence on the one or more attributes of each of said objects. Advantageously not all objects need to be considered through the selection.

The one or more attributes may comprise a location of each of said objects. The processing means may be arranged to select a closest one or more objects in the vicinity of the vehicle. Advantageously only objects having certain location(s) may be considered. The processing means is optionally arranged to select the closest of the one or more objects in each of a plurality of regions in the vicinity of the vehicle. Advantageously only the closest objects are considered.

The one or more attributes may comprise one or more of a velocity or heading of each of said objects. The processing means is optionally arranged to select one or more objects in the vicinity of the vehicle in dependence on the one or both of velocity and heading of each of said objects. Advantageously only some objects are considered depending on their velocity and/or heading.

The processing means may be arranged to determine a classification associated with at least some of the one or more objects. The classification may be indicative of an avoidance requirement for each of the objects. Advantageously only some objects of particular classifications are considered. The classification may be indicative of a type of the one or more objects. The classifications may be indicative of one or more of road markings, a type of road marking, of other vehicles, of static object and living entities e.g. people, dogs etc. Advantageously only objects of certain types are considered.

The solution of the control algorithm for the vehicle optionally comprises the processing means being arranged to determine the one or more control input as an optimal solution of the control algorithm. Advantageously the control inputs are selected which best satisfy the constraints.

The trajectory data may be representative of the desired trajectory for the vehicle up to a sample time. The processing means may be arranged to determine the one or more constraints representative of one or more of the objects in the vicinity of the vehicle up to a second sample time. Optionally the second sample time is less than first sample time.

According to another aspect of the present invention there is provided a system comprising the control system as described above, and control means arranged to receive the one or more signals indicative of the one or more control input for controlling the vehicle and to control the vehicle in dependence thereon. The control means may comprise one or both of a steering control means for controlling a steering system of the vehicle and motion control means for controlling a longitudinal motion of the vehicle. The longitudinal motion may comprise one or both of acceleration and braking. Advantageously the vehicle may accelerate and/or brake in dependence on the control inputs.

According to a further aspect of the present invention there is provided a vehicle comprising the control system as described above or the system as described above.

According to yet another aspect of the present invention there is provided a method, comprising receiving object data indicative of one or more objects in a vicinity of a vehicle and state data indicative of a state of the vehicle, obtaining trajectory data indicative of a desired trajectory for the vehicle, determining one or more constraints for a solution of a control algorithm for the vehicle, wherein each constraint is representative of one or more of the objects in the vicinity of the vehicle and the respective constraint is determined in dependence on one or more attributes of the one or more objects, determining one or more control input for the vehicle in dependence on the solution of the control algorithm for the vehicle, wherein the control algorithm comprises a model associated with the vehicle, state data indicative of a state of the vehicle, the trajectory data and the one more constraints, and output one or more signals indicative of the one or more control input for controlling the vehicle.

Optionally each of the one or more constraints is determined as a risk value indicative of a risk associated with a proximity of the vehicle to the one or more objects.

The method may comprise determining each constraint in dependence on a function of the one or more attributes of the one or more objects represented by the constraint. The function may be representative of an intervention area peripheral to the one or more objects represented by the constraint and a critical area of the one or more objects represented by the constraint.

According to a still further aspect of the present invention there is provided computer software which, when executed by a computer, is arranged to perform a method as described above. Optionally the computer software is stored on a computer readable medium. The computer software may be tangibly stored on the computer readable medium.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an illustration of current and desired state of a vehicle;

FIG. 2 shows an illustration of a vehicle and objects in a vicinity of the vehicle;

FIG. 3 shows a further illustration of a vehicle and objects in a vicinity of the vehicle;

FIG. 4 illustrates zones according to an embodiment of the invention;

FIG. 5 illustrates a system according to an embodiment of the invention;

FIG. 6 illustrates a method according to an embodiment of the invention;

FIG. 7 illustrates risk values according to an embodiment of the invention;

FIG. 8 illustrates a function according to an embodiment of the invention;

FIG. 9 illustrates a gradient of a function according to an embodiment of the invention;

FIG. 10 illustrates a path of a vehicle according to an embodiment of the invention;

FIG. 11 illustrates a further path of a vehicle according to an embodiment of the invention; and

FIG. 12 illustrates a vehicle according to an embodiment of the invention.

### DETAILED DESCRIPTION

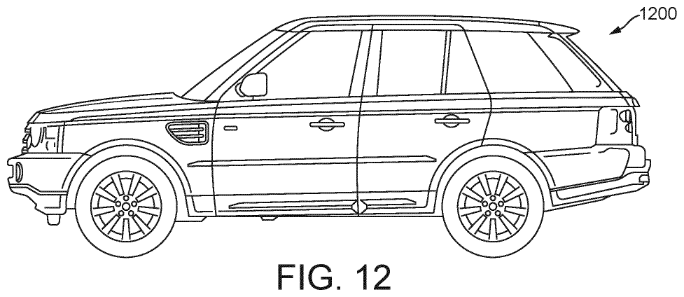

Embodiments of the invention will be described with reference to a vehicle 1200 such as shown in FIG. 12 and particularly to controlling a trajectory of the vehicle 1200. It will, however, be appreciated that embodiments of the invention are not limited in this respect. Embodiments of the invention may be applied to controlling other aspects of the vehicle and, furthermore, may be applied to controlling processes more generally.

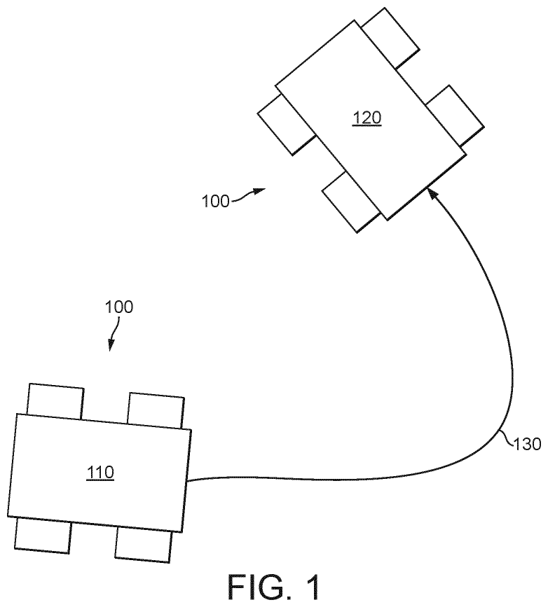

Referring to FIG. 1 there is illustrated a vehicle, generally denoted as 100, illustrated at a first state 110. The first state 110 is a current state of the vehicle at a current or present point in time. For example, the current state 110 may be the vehicle 100 at a position on a navigable path, such as a roadway or other navigable area e.g. off-road area. The first state 110 of the vehicle 100 is at an initial time t₀. FIG. 1 also illustrates a second state 120 of the vehicle 100 at a future point in time i.e. the vehicle is at a desired state 120. The second or desired state 120 of the vehicle 100 may be at time corresponding to a time horizon T. The time horizon is a point in time ahead of an initial time to at which the desired state 120 is determined. It will be appreciated that one or more states of the vehicle 100 at points in time between the first state 110 and the second state 120 may be determined. A desired or reference trajectory 130 of the vehicle 100 between the first state 110 and the second state 120 may be determined, as will be explained. The desired trajectory 130 may comprise a plurality of reference positions between the first and second states 120, 130 as will be explained. The desired trajectory 130 may be determined based on data from one or more sensors, at least some of which may be associated with the vehicle 100, such as lidar or vision-based sensors, and also map data which may define a roadway or navigable area proximal to the vehicle 100.

The first state 110 and the second state 120 of the vehicle 100 may each be defined by one or more parameters. The one or more parameters are each indicative of an aspect of the vehicle's state. For example, a first parameter may define the vehicle's position. For a vehicle 100 which travels on the surface of the Earth, including upon water, the position may be defined in two dimensions such as in x, y coordinates. It will be appreciated that for air-going vehicles the position may be defined in three dimensions such as x, y, z coordinates. Thus it will be appreciated that one parameter, such as location, may comprise a plurality of dimensions. Although description is provided herein relating to land-going vehicles, such as wheeled vehicles, it will be appreciated that embodiments of the invention are not limited in this respect. Embodiments of the invention may be envisaged which are used with watercraft or aircraft, such as autonomous or unmanned aircraft, i.e. drones.

The state of the vehicle 100 may also be defined by a heading parameter θ which defines a direction in which the vehicle 100 is facing i.e. oriented. Particularly, although not exclusively, for vehicles not having a front face i.e. which may travel in any direction, θ may indicate the direction of travel of the vehicle 100. In some embodiments θ may indicate an angle between the direction of travel and a reference axis, such as a north or east coordinate axis for example. The state of the vehicle 100 may be defined by other parameters such as, for example V indicative of a velocity of the vehicle 100.

As noted above, in a Model Predictive Control (MPC) control scheme the current state 110 of the vehicle, as defined by x(t₀), i.e. x at time t₀, and one or a plurality of desired states 120 of the vehicle 100, such as the second state 120, are used to determine control inputs for the vehicle 100. The control inputs are those inputs which are to be applied to the vehicle 100 to achieve the desired state(s) 120 from the current state 110 as closely as possible. In some embodiments, a plurality of desired states of the vehicle 100 may represented by a vector of a plurality of desired states 120 of the vehicle 100 at respective points in time, whereas in continuous time a desired trajectory 130 of the vehicle is considered, as discussed below.

The MPC control scheme determines control inputs for the vehicle 100 to achieve or track the one or more desired states i.e. to follow or track the desired trajectory 130. In some embodiments, the control inputs are represented by U which is a vector of a plurality of control inputs of the vehicle 100 at respective points in time. In continuous time, control inputs for the vehicle 100 may be defined as u_{ref}(t) as discussed below. It will be appreciated that the control inputs u_{ref}(t) may be provided as a user input.

In continuous time, the desired state 120 of the vehicle 100 may be represented by the desired trajectory 130, which is given by:

(x_{ref}(t),u_{ref}(t))∀t∈[t₀;t₀+T]

Where x_{ref}(t) is the desired state 120, i.e. state along the desired trajectory 130, of the vehicle 100 at time t, u_{ref}(t) is one or more control input for the vehicle 100 such as steering etc., at time t, where t is the current time and T is the time horizon as mentioned above. If the vehicle where to behave exactly as the model predicts, then the state of the vehicle x would follow x_{ref}(t) when using u_{ref}(t) as a control input, as can be appreciated.

The desired trajectory 130 can be sampled at a given sampling rate DT to provide the state of the vehicle 100 at each sampling interval. Interpolation between sampling intervals may be made according to one or more strategies known to the skilled person, such as zero holder or linear interpolation, for example.

To determine the control inputs for the vehicle 100 to follow the desired trajectory 130, it is necessary to have a model of the vehicle 100. The model of the vehicle 100 may be given by a differential equation. The differential equation may be a functional equation such as a time varying differential algebraic equation. The differential equation may be of the form:

$$\{ \begin{matrix}\frac{dx}{dt} = f ( x , u ) \\ x ( {t}_{0} ) = {x}_{0}\end{matrix}$$

Where x is the state of the vehicle over time t which is a function ƒ of the state of the vehicle x, where x₀ is the initial state at t₀, and the control inputs u. The function ƒ may be a set of functions which model behaviour of the vehicle 100, where the functions may be smooth equations in some embodiments.

A performance criterion is used to measure how well the vehicle 100 is tracking the desired trajectory 130 at a given instant in time t. An example performance criterion may be of the form:

l(x(t),u(t),x_{ref}(t),u_{ref}(t))

Where l(.) is a function of sufficient smoothness, such as

l(x,x_{ref})=(x−x_{ref})^{T}R(x−x_{ref})+(u−u_{ref})^{T}Q(u—u_{ref})

Where T is a matrix transposition, R is a matrix which weights a relative importance of track each individual vehicle state (for example, heading may be more important than position) and Q is a matrix which is used to determine a compromise between control effort and tracking performance. It will be appreciated that other functions may be used.

It is possible to include one or more constraints in the control algorithm, such as the MPC control algorithm, such as to represent performance limits for the vehicle 100. The constraints may force one or more of a speed, lateral or longitudinal acceleration of the vehicle to be bounded. The constraints may be written of the form:

x(t)∈X

u(t)∈U

Where X and U represent the constraints on the state of the vehicle 100 and control inputs, respectively.

A control algorithm for the vehicle 100 is then represented by:

$${J}^{*} ( {t}_{0} ; {u}^{*} , {x}_{0} ) = min {\int }_{{t}_{0}}^{{t}_{0} + T} l ( x ( s ) , u ( s ) , {x}_{ref} ( s ) , {u}_{ref} ( s ) ) ds$$

$$s . t . \begin{matrix}\{ \begin{matrix}\frac{dx}{dt} = f ( x , u ) \\ x ( {t}_{0} ) = {x}_{0}\end{matrix} \\ \begin{matrix}x ( t ) ∈ X \\ u ( t ) ∈ U\end{matrix} ∀ t ∈ [ {t}_{0} , {t}_{0} + T ]\end{matrix}$$

Where J is a cost function for the control algorithm and J* is an optimal solution i.e. having a lowest cost. The control algorithm is performed by an MPC controller which attempts to determine the optimal solution i.e. lowest cost for the control inputs u* of the vehicle 100. The MPC controller is arranged to repeatedly attempt to determine the optimal solution for the control inputs. For example, the MPC controller may execute repeated iterations of attempting to solve the control algorithm by finding the lowest cost solution for the control inputs. The optimal solution may be the solution having the lowest cost capable of being determined within a given period of time by the controller, which may be at a point in time at which a new optimisation problem needs to be solved i.e. the MPC controller may be allowed a period of time to determine the optimum solution, i.e. solution with least error or cost, for each iteration of the control algorithm.

To solve the control algorithm, i.e. to define a minimum cost solution, an optimisation solver may be used. The optimisation solver may be an iterative solver. Such an iterative solver may be one of a gradient descent, conjugate gradient, Newton algorithm etc as will be appreciated by the skilled person. In general such solvers rely on computing one or more derivatives of the control algorithm and attempting to find a solution to the optimality conditions e.g. in an unconstrained case, this is equivalent to setting the gradient at 0 and finding a solution to the above equations. In some embodiments, Karush Kuhn Tucker (KKT) conditions may be used for finding the optimum solution, as will be appreciated.

Whilst the desired trajectory may be initially determined for the vehicle 100 to avoid objects, in some cases a location of one or more objects may change, or one or more additional objects may be determined such as being newly detected by sensors associated with the vehicle. For example, in the former case, some objects are dynamic in that they are moving in real time i.e. vehicles, people, animals etc. In the latter case, whilst the desired trajectory 130 may be determined to avoid objects which are detectable to the vehicle 100 between to and T, some objects may only be detected at a range or distance from the vehicle 100 less than T for example by more sensitive sensors having a shorter range. Thus, in some instances, a time horizon at which objects can be detected, with sufficient accuracy, may be a second time horizon less than T. In these cases it is necessary for the vehicle 100 to pre-emptively avoid the detected objects as will be explained. However, embodiments of the present invention may also be used to determine the desired trajectory by avoiding objects detected at the initial time to. Embodiments of the present invention aim to control the vehicle 100 to avoid the position, or predicted position, of one or more objects whilst following, as much as possible, the desired trajectory 130.

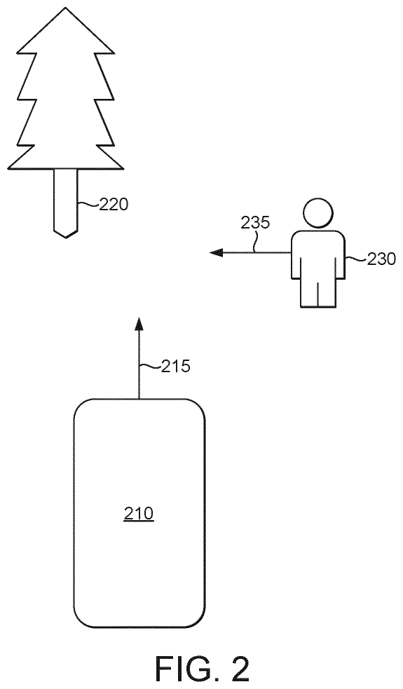

FIG. 2 illustrates a vehicle 210 moving in a direction indicated by arrow 215 along determined a desired trajectory. A first static object 220 is present at a location which is proximal to the direction of travel 215 of the vehicle 210. Furthermore, a second object, in the example a person 230, is a dynamic or moving object which is moving in a direction 235. The direction 235 of movement of the second object 230 converges with the direction 215 movement of the vehicle 210. Thus, although the second object 230 is not currently located within a path of the vehicle 210, its direction 235 of movement may bring it into the path of the vehicle 210 along the desired trajectory of the vehicle 210 at a future point in time. Whilst the first and second objects are 3D objects i.e. also having a substantial height above ground, it will be appreciated that objects may also be generally 2D objects such as road markings which may not have a substantial height, but which it is also desired to avoid by the vehicle 210.

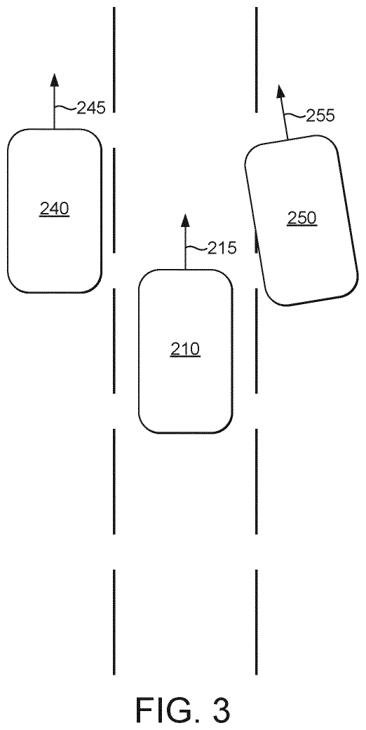

FIG. 3 illustrates a portion of a roadway having a plurality of lanes. In the illustration there are three lanes on which vehicles may travel. A vehicle 210 is present in a middle lane travelling in a direction 215 generally parallel with the road with other vehicles 240, 250 present in adjacent lanes. The vehicle 210 is following a desired trajectory along its respective lane of the roadway. The adjacent vehicles 240, 250 are at least initially travelling generally parallel with the road. One of the adjacent vehicles 240 is travelling in direction 245. The other vehicle 250 deviates from the direction parallel to the road to travel in direction 255 which intersects with the direction of travel of vehicle 210 i.e. the vehicle 250 begins to change lanes which may be intentional or for example to avoid debris in the roadway.

In the examples shown in FIGS. 2 and 3 it is desirable for the vehicle 210 under control to avoid the objects 220, 230, 250 either because of their current location or because of their potential future location with respect to the desired trajectory of the vehicle 210.

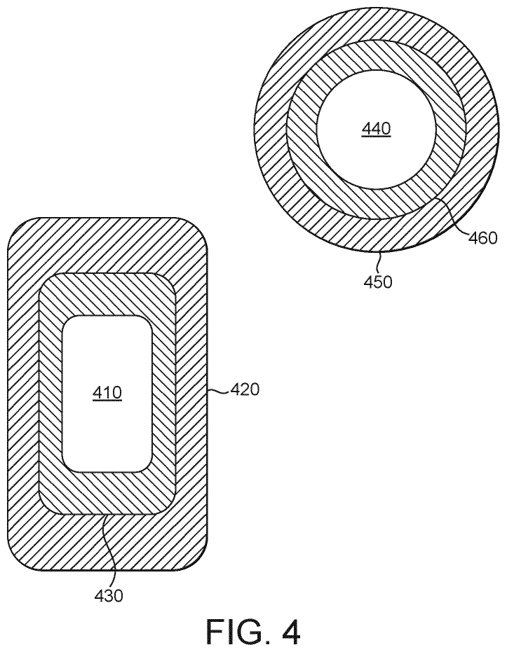

Referring to FIG. 4 a vehicle 410 and an object 440 are illustrated. Embodiments of the present invention utilise at least one of an area of intervention 420, 450 and a critical area 430, 460 as will be explained. The area of intervention 420, 450 and a critical area 430, 460 are utilised in embodiments of the invention to determine control inputs for the vehicle 410. Although shown associated with both the vehicle 410 and the object 440 in FIG. 4, in some embodiments of the invention the area of intervention 420, 450 and the critical area 430, 460 may only be associated with one of the vehicle 410 and the object 440. The area of intervention 420, 450 is an area for which control inputs are determined, or further control inputs determined, to avoid the vehicle 410 and the object simultaneously being present within the respective areas 420, 450 i.e. to avoid the object 440 entering into the area of intervention 420 of the vehicle 410 and vice versa. The area of intervention 420, 450 extends a first distance from the vehicle 410 or the object 440, thereby defining a first area around the vehicle 410 or the object 440. The critical area 430, 460 is an area for which maximum control inputs are determined to avoid the vehicle 410 and the object 440 simultaneously being present within i.e. to avoid the object 440 entering into the critical area 440 of the vehicle 410 and vice versa.

The critical area 430, 460 extends a second distance from the vehicle 410 or the object 440, thereby defining a second area around the vehicle 410 or the object 440. The first distance may be greater than the second distance, such that the critical area 430, 460 is within the area of intervention 420, 450 surrounding the vehicle 410 or the object 440 respectively. In some embodiments the first and second distances are predetermined. However in other embodiments one or both of the first distance and the second distance may be dynamically determined. For example, the first distance controlling the area of intervention 420, 450 may be determined dependent on a speed of the vehicle 410. Still further, in some embodiments a type of object 440 may be determined and one or both of the first distance and the second distance controlled in dependence thereon. For example, if the object 440 is determined to be a living being, such as a person or animal, the first distance may be increased in order to aim for the vehicle to avoid the living being by a greater distance.

For explanation of embodiments of the invention, the object 440 will be associated with the area of intervention 420, 450 and the critical area 430, 460 although it will be appreciated that this is an example with it being appreciated that, alternatively, the vehicle 410 may be associated with said areas.

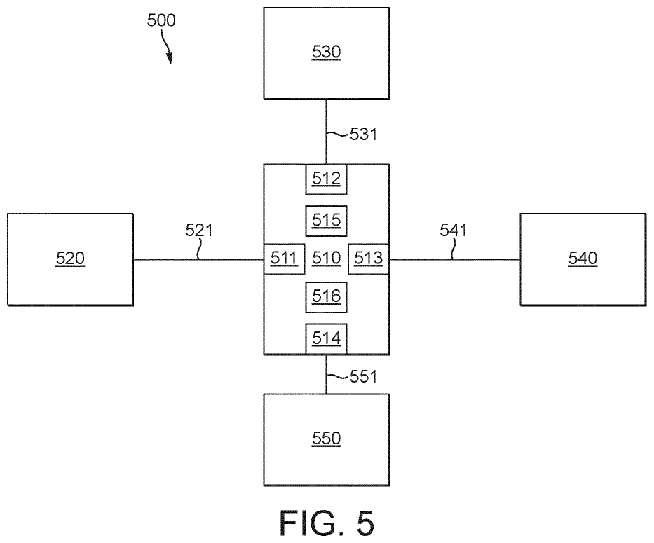

FIG. 5 illustrates a system 500 for the vehicle 100 according to an embodiment of the invention. The system 500 comprises a control means 510 according to an embodiment of the invention, current state determining means 520 for determining one or more parameters of a current state of the vehicle 100, desired trajectory determining means 530, sensing means 540 for determining one or more attributes of objects proximal to the vehicle 100 and vehicle control means 550.

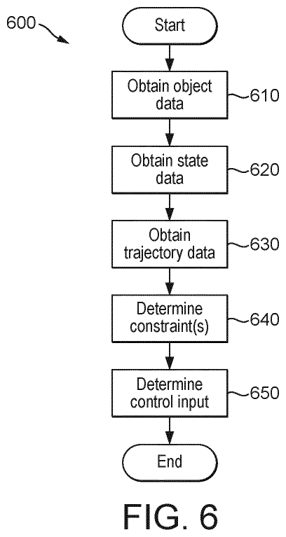

The control means 510 may comprise electronic circuitry. The control means 510 may be a control device or controller 510. The control means 510 may comprise one or more electronic processing devices 515, or processors, which operably execute computer-readable instructions. The computer-readable instructions may be stored in a memory 516, which may be formed by one or more memory devices 516, or data storage device accessible to the one or more electronic processing devices 515. The computer readable instructions may, when executed, cause the one or more electronic processing devices 515 to implement a method according to an embodiment of the invention, such as that illustrated in FIG. 6.

The control means 510 comprises input means 511 to receive a signal 521 indicative of the current state of the vehicle 100. The signal 521 may be an electronic signal which is indicative of current state data. The current state data may be provided by the current state determining means 520. The input means may be an electrical input of the processing device 515.

The control means 510 may comprise input means 512 to receive a signal 531 indicative of the desired trajectory of the vehicle 100. The signal may be an electronic signal which is indicative of desired trajectory data. The input means 512 may be an electrical input of the processing device 515. The desired trajectory data may be provided by the desired trajectory determining means 530. In some embodiments, the desired trajectory determining means 530 may be a software module executed by the control means 510. In which case, the desired trajectory data may be stored in the memory 516 of the control means 510. Thus the control means obtains the desired trajectory data via the signal 531 or by said data being stored or provided to the memory 516, such as by the desired trajectory determining means 530 directly storing the data in the memory 516 i.e. where the memory 516 is shared.

The control means 510 comprises input means 513 to receive a signal 541 indicative of one or more objects in a vicinity of the vehicle 100, such as the objects 220, 230, 250, 440 discussed above. The input means 513 may be an electrical input of the processing device 515. The signal 541 may be indicative of at least one attribute of the one or more objects in the vicinity of the vehicle 100. The signal 541 may be an electronic signal which is indicative of the object data. The object data may be provided by the sensing means 540. The sensing means 540 may comprise one or more sensing devices 540. The sensing devices 540 may comprise one or more of LIDAR, one or cameras or other devices for receiving radiation. Other types of sensing device may be envisaged. The object data may be indicative of a current location of each of the one or more objects, which may be a location with respect to a location of the vehicle. The object data may also indicate a velocity and direction of movement of at least some of the one or more objects, or the velocity and direction of movement may be determined based upon the location of each object at one or more points in time, as will be appreciated. The control means 510 may be arranged to determine the type of object in dependence on the object data 541 in some embodiments. In other embodiments, the control means 501 may receive an indication of the type of object.

The control means 510 comprises output means 514 to output a signal 551 indicative of one or more control input which are provided to the vehicle 100. The signal 551 may be an electronic signal, hereinafter vehicle control signal, which is indicative of the one or more vehicle control inputs, u. The control signal 551 may be provided to the vehicle control means 550. The output means 514 may comprise an electric output.

The current state determining means (CSDM) 520 is arranged to, in use, determine one or more parameters of the current state of the vehicle 100. The CSDM 520 may comprise one or a plurality of devices for determining each respective parameters of the current state. The CSDM 520 may comprise a magnetometer device for determining a current heading of the vehicle 100. The current state determining means 520 may comprise a location determining device which may comprise a receiver for receiving wireless navigation signals, such as from GPS or GLONASS satellites, from which the location of the vehicle may be determined. The CSDM 520 may comprise other devices such as an altimeter device for determining an altitude of the vehicle 100, one or more scanning devices for scanning i.e. transmitting and receiving radiation from an environment of the vehicle 100, such as LIDAR. The CSDM 520 may comprise imaging means, such as one or more imaging devices, for outputting image data corresponding to the environment of the vehicle 100, such as one or more cameras. Other devices may be envisaged which are useful for determining parameters of the vehicle's current state. The CSDM 520 may output the current state data x(to) 521 indicative of the one or more parameters of the vehicle's current state. The current state data 521 may be indicative of the vehicle's position or location and the vehicle's current heading.

The desired trajectory determining means (DTDM) 530 may comprise electronic circuitry. The DTDM 510 may comprise one or more electronic processing devices, or processors, which operably execute computer-readable instructions. The computer-readable instructions may be stored in a memory accessible to the one or more electronic processing devices. The computer readable instructions may, when executed, cause the one or more electronic processing devices to determine a desired trajectory for the vehicle 100. The desired trajectory may be determined in dependence a desired position of the vehicle 100 along a navigable path or within a navigable area, such as a road, or a parked position of the vehicle 100. The DTDM 530 may be provided with the current state data from the current state determining means 520. The DTDM 330 may be arranged to access digital map data, such as stored in a storage means accessible to the DTDM 530, indicative of a layout or geometry of the navigable path from which the desired state may be determined. The DTDM 530 may, for example, receive image data provided by the current state determining means 520 or the sensing means 540 in order to determine a parked location of the vehicle relative to one or more obstacles in the environment of the vehicle 100, such as other parked vehicles. The DTDM 530 provides the desired trajectory data x_{ref}(t), u_{ref}(t) 531 for a time period between the current time and a future point in time to the control means 510.

The vehicle control means (VCM) 550 is provided, as an input, with the vehicle control signal 551, u, from the control means 510. The VCM 550 comprises means for controlling the state of the vehicle 100. The VCM 550 may be arranged to influence, or control, the one or more parameters of the vehicle's state determined by the CSDM 520. For example, the VCM 550 is operative to control the heading and position of the vehicle 100. The VCM 550 may comprise means for controlling the heading of the vehicle 100, such as a steering controller. The steering controller may be associated with one or more actuators arranged to move a steering system of the vehicle, which may comprise one or more steering wheels of the vehicle 100. The VCM 550 may comprise means for controlling the position of the vehicle 100 which may comprise the steering controller and a motive controller for controlling motion of the vehicle, such as in forward and backward directions, although for some vehicles the motive controller may comprise means for controlling an altitude of the vehicle 100, such as by controlling a speed of a motor providing torque to a propeller or rotor of the vehicle.

FIG. 6 illustrates a method 600 according to an embodiment of the invention. The method 600 is a method of determining a control input u for a vehicle 100. The control input u may be one or more steering inputs and/or throttle inputs controlling an application of torque to one or more wheels of the vehicle 100. The control input u may be determined to avoid one or more objects such as the objects 220, 230, 250, 440 discussed above with respect to FIGS. 2-4.

In step 610 object data indicative of one or more objects 220, 230, 250 in a vicinity of a vehicle 100, 210, 410 is determined. The object data 541 may be indicative of a location of each object 220, 230, 250. The object data 541 may indicate a distance of the object 220, 230, 250 from the vehicle 100, 210, 410 in some embodiments, or the distance may be determined based on the location of each object 220, 230, 250 with respect to the vehicle 100, 210, 410 as will be appreciated. The object data may be indicative of one or more attributes of each of the objects 220, 230, 250. The attribute may represent a type of the object, which may be represented as one of a plurality of predetermined object types. The object types may be indicative of the object being a surface marking i.e. marking on a road or navigable area, an inanimate object such as vehicle, tree, wall etc, or a living object such as a person or animal. It will be appreciated that these types are merely examples and that others may be envisaged. The object data 541 may be received from the one or more sensing devices 540.

In step 620 state data indicative of the state of the vehicle 100, 210, 410 is obtained. The state data may be received from the CSDM 520 as the signal 521 described above. The state data may indicate a position or location of the vehicle 100, 210, 410 and a heading θ of the vehicle 100, 210, 410 at the current time, which at a start of the method may be to.

Step 630 comprises obtaining trajectory data indicative of a desired trajectory for the vehicle. The desired trajectory 130 for the vehicle 100, 210, 410 may have been determined prior to a current iteration of the method 600 i.e. before to. The desired trajectory 130 may have been determined by the DTDM 530 and data indicative of the desired trajectory stored in the memory 516 of the controller 510. The desired trajectory 130 may have been determined to avoid a location of one or more objects detected at that time one or more sensors, such as the sensing devices 540 associated with the vehicle 100, 210, 410. The desired trajectory 130 may have been determined based upon a direction of movement or estimated trajectory of the one or more objects 220, 230, 250, 440, which may subsequently have changed. For example, where an object is a vehicle or person, the velocity or the direction of movement of the vehicle or person may change.

Step 640 comprises determining one or more constraints for a solution of a control algorithm for the vehicle 100, 210, 410. The one or more constraints for the control algorithm is representative of one or more of the objects in the vicinity of the vehicle 100, 210, 410. The constraint is determined in dependence on an attribute of the one or more objects 220, 230, 250, 440. In some embodiments, a constraint is determined for each respective object 220, 230, 250, 440 in the vicinity of the vehicle 100, 210, 410. As will be explained, the attribute is, in some embodiments, a distance between the vehicle 100, 210, 410 and the one or more objects 220, 230, 250, 440. For ease of explanation, one object and associated constraint may be referred to in the following description.

In embodiments of the invention, the attribute on which the constraint is determined comprises a distance between the vehicle 100, 210, 410 and each of the one or more objects 220, 230, 250, 440. In some embodiments, the constraint may be determined to be satisfied, i.e. to not significantly affect the control algorithm, when the distance between the vehicle 100, 210, 410 and the one or more objects 220, 230, 250, 440 is sufficient i.e. at least a particular distance. In some embodiments, when the distance between the vehicle 100, 210, 410 and the one or more objects 220, 230, 250, 440 is greater than the first distance referred to above i.e. the object 220, 230, 250, 440 is outside of the intervention area 420 of the vehicle, or vice versa i.e. the vehicle 410 is outside of the intervention area 450 of the object 440. When the object 440 enters the intervention area 420, the constraint is required to be satisfied to find the solution for the control algorithm to determine the control inputs for the vehicle 410. In this way, the vehicle 410 is controlled to avoid the object 440 by the control input i.e. for the object 440 to be outside of the intervention area 420 or vice versa.

In some embodiments, the constraint is represented by a risk function r which is required to adopt a risk value less than or equal to a predetermined risk threshold rₜₕ. The constraint may be:

r(x,x_{object})≤rₜₕ

Where x represents the state of the vehicle 410 and x_{object} represents the state of the object 440. The constraint may be determined to be satisfied when r≤rₜₕ for every object.

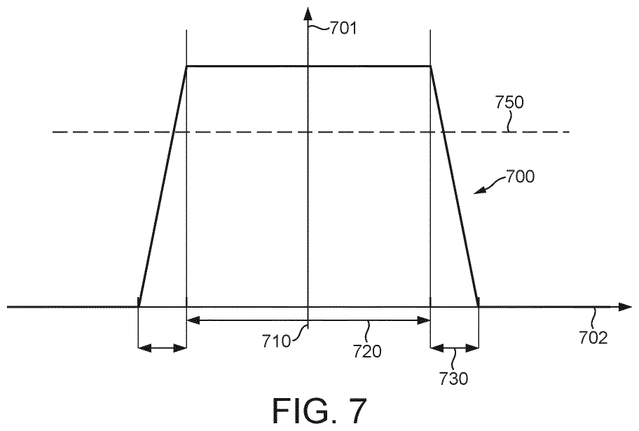

In some embodiments of the invention, the function to determine the risk value r is a bump function. A bump function 700 according to an embodiment of the invention is illustrated in FIG. 7. The axes of FIG. 7 represents an evaluated risk value 701 of the bump function 700 against distance 702. In FIG. 7 710 represents a location of the vehicle 410. Reference 720 represents the second distance i.e. the critical area 430, 460 extending outwardly around the vehicle 410 and 730 is indicative of the first distance i.e. the area of intervention 420, 450 surrounding the vehicle 410. As 710 is shown in FIG. 7 as a point location it may be taken to represent an outer periphery of the vehicle in some embodiments, or may represents a centre of the vehicle in other embodiments. As can be seen, within the area of intervention 730 the risk value r rises with decreasing distance from the vehicle 710. In the illustrated embodiment the risk value r increases linearly, however it will also be appreciated that other functions may be used such as an exponential, for example. Within the critical area 720 the risk value r is constant in some embodiments of the invention. The risk value r within the critical area 720 may be a predetermined maximum value such as 1 in some embodiments, although other values may be selected. Outside of the area of intervention 420, 450 the value of r is a minimum which may be 0 in some embodiments.

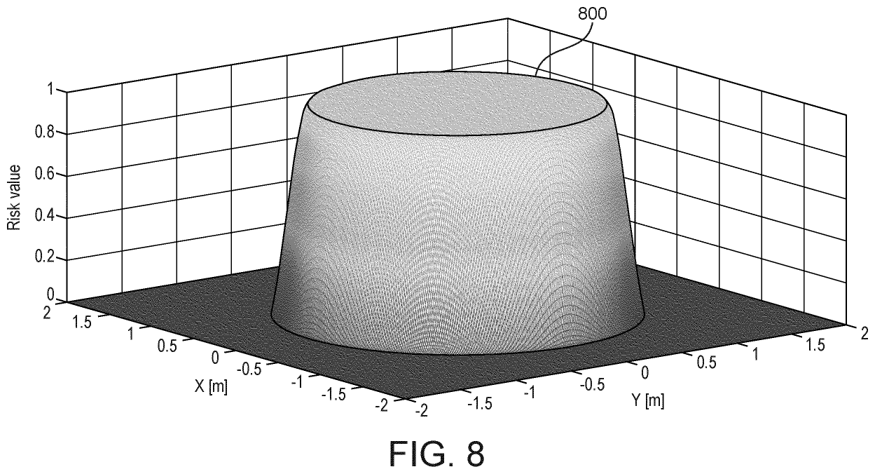

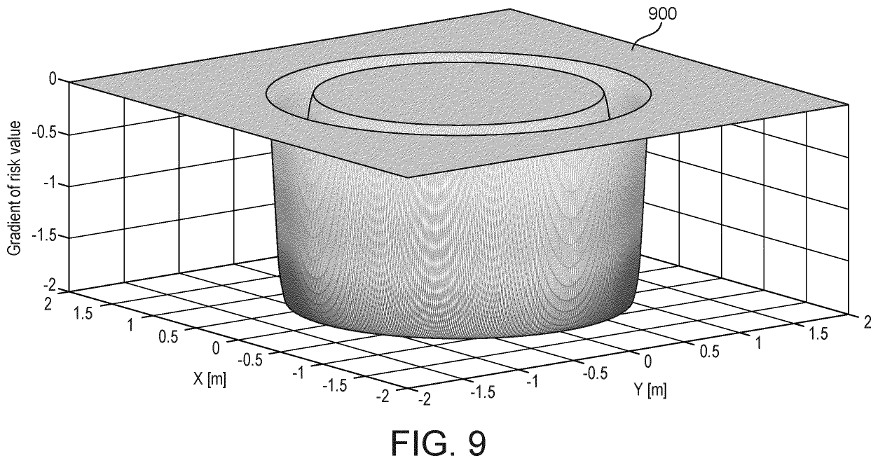

FIGS. 8 and 9 illustrate, respectively, a value 800 of r and a gradient 900 of the bump function according to an embodiment of the invention.

It can be appreciated that for a bump function if an object is sufficiently far from the vehicle then r≤rₜₕ and no further constraint is advantageously imposed by the function. If however the object enters the area of intervention then r evaluates to a value which may modify a solution of the control algorithm, thereby impacting a control input to the vehicle.

A control algorithm including the one or more constraints representative of one or more of the objects in the vicinity of the vehicle 100, 210, 410 is given in step 650 in some embodiments by:

$${J}^{*} ( {t}_{0} ; {u}^{*} , {x}_{0} ) = min {\int }_{{t}_{0}}^{{t}_{0} + T} l ( x ( s ) , u ( s ) , {x}_{ref} ( s ) , {u}_{ref} ( s ) ) ds$$

$$s . t . \begin{matrix}\{ \begin{matrix}\frac{dx}{dt} = f ( x , u ) \\ x ( {t}_{0} ) = {x}_{0}\end{matrix} \\ \begin{matrix}x ( t ) ∈ X \\ u ( t ) ∈ U\end{matrix} ∀ t ∈ [ {t}_{0} , {t}_{0} + T ] \\ r ( x , {x}_{obs} ) \leq {r}_{th} for all objects\end{matrix}$$

As can be appreciated, the control inputs for the vehicle is determined in dependence on the model associated with the vehicle, the state data, the trajectory data and a constraint for each object to determine the control inputs for the vehicle 100, 210, 410. However, to solve the modified control algorithm an iterative solver may be used with the bump function 800 due to its smoothness. Instead, according to an embodiment of the invention, the control algorithm may be solved as a non-smooth optimisation problem. An advantage of a bump function for r is that the bump function 800 is smooth, which may be some embodiments be C. The gradient of the bump function shown in FIG. 8 illustrates that the bump function is well defined, thereby illustrating that the bump function is C.

As noted above, the attribute of the object may be a distance of the object. In some embodiments, the bump function used in step 640 may be:

$$r ( x , {x}_{obj} ) = \frac{f ( {r}_{int} - d ( x , {x}_{obj} ) )}{f ( d ( x , {x}_{obj} ) - {r}_{crit} ) + f ( {r}_{int} - d ( x , {x}_{obj} ) )}$$

Where ƒ(rᵢₙₜ−d(x,x_{obj})) is a function of the second distance i.e. a radius rᵢₙₜ of the area of intervention 420, 450 and distance d(x,x_{obj}) between the vehicle 410 and the object 440, as illustrated particularly in FIG. 4, and ƒ(d(x,x_{obj})−r_{crit}) is a function of the first distance i.e. a radius r_{crit} of the critical area 430, 460 and distance d(x,x_{obj}) between the vehicle 410 and the object 440. In some embodiments, the value of one or both of rᵢₙₜ and r_{crit} may vary according to, for example, a velocity of the vehicle or the type of object.

In some embodiments, the function d(.) is the squared Euclidian distance representing an approximate distance between the vehicle 410 and the object 440, which may be expressed as:

d(x,x_{obj})=((X−X_{obj})²+(Y−Y_{obj})²)

Where X, X_{obj}, Y and Y_{obj} are X and Y coordinates of the location of the vehicle and the object. In FIGS. 8 and 9 X_{obj}=Y_{obj}=0. As will be appreciated, this function is close to the Euclidian distance, and makes the bump function continuously derivable, which advantageously simplifies the solution to the control algorithm. Therefore it can be appreciated that one or more constraints vary in dependence on the one or more attributes, such as distance, of the one or more objects represented by the constraints.

In some embodiments, the function ƒ may be expressed as:

$$f ( s ) = \{ \begin{matrix}{e}^{- 1 / s} , & s > 0 \\ 0 , & s \leq 0\end{matrix}$$

In some embodiments, the one or more attributes of the object may comprise a type of the object. The type of the object may be represented as one of a plurality of predetermined object types. The object types may be indicative of the object being a surface marking i.e. marking on a road or navigable area, an inanimate object such as vehicle, tree, wall etc, or a living object such as a person or animal. Thus the above function may include a variable associated with the type of object, such that, for example, living objects are given greater priority to be avoided.

In some embodiments, in step 640, a subset of the one or more objects may be selected to determine the one or more constraints. Advantageously, selecting some of the detected objects may reduce computational requirement of the control algorithm.

The object data received from the sensing devices 540 by the controller 510 is indicative of the one or more attributes of each of the one or more objects in the vicinity of the vehicle. At least some of the objects in the vicinity of the vehicle are selected in step 640 in dependence on the one or more attributes of each of said objects. The one or more attributes on which the selection is performed may comprise a location of each of said objects. In one embodiment, a closest one or more objects in the vicinity of the vehicle may be selected i.e. such that only a predetermined number of closest objects to the vehicle are selected. For example, a closest 2 or 5 objects may be selected as constraints.

Where at least some of the objects are dynamic i.e. moving, the one or more attributes of those objects may comprise, for example, one or both of a velocity and a direction of motion of each of said objects. Thus at least some of the one or more objects in the vicinity of the vehicle may be selected in dependence on the velocity of each of said objects. For example, a predetermined number of objects may be selected in dependence on their respective velocity i.e. to select the fastest predetermined number of objects for the constraints.

In some embodiments, the vicinity of the vehicle may be divided into a plurality of regions. For example, the vicinity around the vehicle may be divided into two or more sectors, such as arranged radially around the vehicle. A predetermined number of objects in each sector may be selected, such as according to distance i.e. a closest object in each sector may be selected to form a constraint in one embodiment. Advantageously such selection provides coverage broadly around the vehicle for objects.

Thus in step 640 the one or more constraints for the control algorithm are determined as described above.

In step 650, once a solution for the control algorithm has been found which provides one or more control input for the vehicle, the one or more control input are used to control the vehicle. In the system of FIG. 5, the control means 510 is arranged to output the control signal 551 to the vehicle control means 550 where the control signal 551 is indicative of the one or more control input for the vehicle. The control inputs may control a steering of the vehicle so as to avoid the objects represented in the control algorithm described above. The control inputs may control a longitudinal motion of the vehicle in some embodiments, for example to control acceleration or braking of the vehicle. For example, the vehicle may be caused to accelerate (which may be controlled to be within legal boundaries, such as maximum speed) or brake to avoid an object.

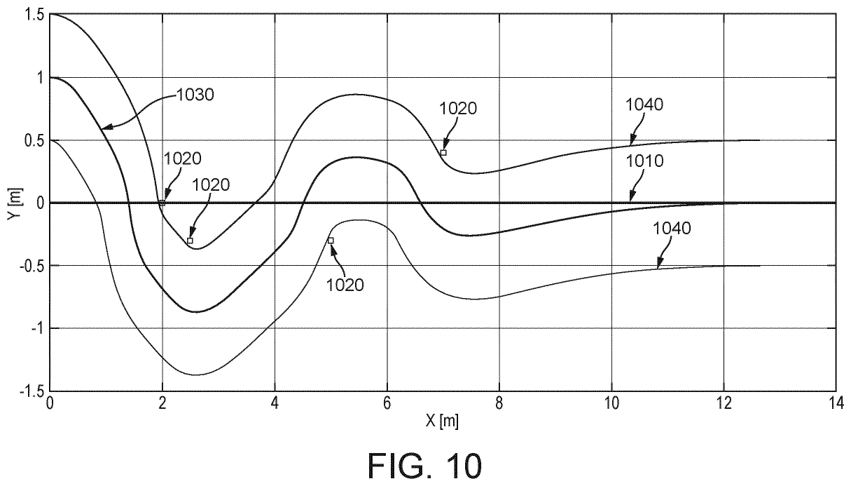

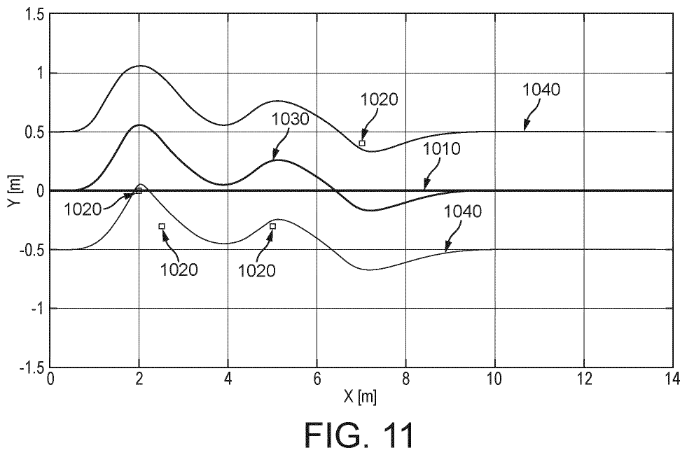

FIGS. 10 and 11 illustrate a trajectory of vehicles controlled according to an embodiment of the invention. A desired trajectory 1010 for the vehicle is illustrated in each of FIGS. 10 and 11 along with objects 1020 detected at various locations with respect to the desired trajectory 1010. A trajectory 1030 of the vehicle resulting from control inputs determined according to an embodiment of the invention is illustrated. In FIG. 10 the vehicle is at an initial point at x=0 which is not coincident with the desired trajectory 1010, whereas in FIG. 11 the initial location of the vehicle is coincident with the desired trajectory 1010. Also illustrated is a path of a periphery of the area of intervention 1040 of the vehicle. As can be appreciated, the vehicle is controlled such that the area of intervention 1040 avoids the obstacles whilst attempting to follow the desired trajectory 1010.

FIG. 12 illustrates a vehicle 1200 according to an embodiment of the invention. The vehicle 1200 is a wheeled vehicle. It will be appreciated that embodiments of the invention may be applied to other types of vehicles, such as tracked vehicles, aircraft and watercraft, for example. The vehicle 1200 comprises a control system 500 according to an embodiment of the invention. The vehicle 500 may comprise one or more controllers arranged to perform a method according to an embodiment of the invention such as illustrated in FIG. 6.

It will be appreciated that various changes and modifications can be made to the present invention without departing from the scope of the present application.

1. A control system comprising one or more controllers, the control system comprising:
one or more inputs means configured to receive object data indicative of one or more objects in a vicinity of a vehicle and state data indicative of a state of the vehicle;
one or more memory devices configured to store data indicative of a model associated with the vehicle; and
one or more processing devices arranged to determine one or more control inputs for the vehicle,
wherein determining one of the one or more control inputs comprises the one or more processing devices:
obtaining trajectory data indicative of a desired trajectory for the vehicle;
determining a constraint for a solution of a control algorithm for the vehicle, wherein the constraint is representative of one or more of the one or more objects in the vicinity of the vehicle and the constraint is determined in dependence based at least in part on an attribute of each of the one or more objects; and
determining the one or more control inputs for the vehicle based at least in part on the solution of the control algorithm for the vehicle, wherein the control algorithm comprises the model associated with the vehicle, the state data, the trajectory data and the constraint; and
an output arranged to output a signal indicative of the one or more control inputs for controlling the vehicle.

2. The control system of claim 1, wherein the one or more processing devices are arranged to determine each constraint based at least in part on each attribute of the one or more objects represented by the constraint.

3. The control system of claim 1, wherein the one or more processing devices are arranged to determine each constraint based at least in part on a function of each attribute of the one or more objects represented by the constraint.

4. The control system of claim 3, wherein the function is representative of an intervention area peripheral to the one or more objects represented by the constraint and a critical area of the one or more objects represented by the constraint.

5. The control system of claim 1, wherein the one or more processing devices are arranged to determine the solution of the control algorithm for the vehicle in dependence on each constraint and a predetermined risk threshold.

6. The control system of claim 1, wherein the object data is indicative of each attribute of each of the one or more objects in the vicinity of the vehicle, and the one or more processing devices are arranged to select at least some of the one or more objects in the vicinity of the vehicle based at least in part on each attribute of each of said objects.

7. The control system of claim 6, wherein each attribute comprises a location of each of said objects and the one or more processing devices are arranged to select a closest one or more of the one or more objects in the vicinity of the vehicle.

8. The control system of claim 6, wherein each attribute comprises one or more of a velocity or heading of each of said objects and the one or more processing devices are arranged to select one or more objects in the vicinity of the vehicle based at least in part on the one or both of velocity and heading of each of said objects.

9. The control system of claim 1, wherein the one or more processing devices are arranged to determine a classification associated with at least some of the one or more objects, wherein the classification is indicative of an avoidance requirement for each of the one or more objects.

10. The control system of claim 1, wherein the solution of the control algorithm for the vehicle comprises the one or more processing devices being arranged to determine the one or more control inputs as an optimal solution of the control algorithm.

11. The control system of claim 1, wherein the trajectory data is representative of the desired trajectory for the vehicle up to a first sample time, and the one or more processing devices are arranged to determine each constraint representative of one or more of the one or more objects in the vicinity of the vehicle up to a second sample time that is less than the first sample time.

12. A system, comprising:
the control system of claim 1; and
control means arranged to receive the signal indicative of the one or more control inputs for controlling the vehicle and to control the vehicle in dependence thereon.

13. A vehicle comprising the control system claim 1.

14. A method, comprising:
receiving object data indicative of one or more objects in a vicinity of a vehicle and state data indicative of a state of the vehicle;
obtaining trajectory data indicative of a desired trajectory for the vehicle;
determining one or more constraints for a solution of a control algorithm for the vehicle, wherein each constraint is representative of one or more of the one or more objects in the vicinity of the vehicle and a respective constraint is determined based at least in part on one or more attributes of the one or more objects;
determining one or more control input for the vehicle in dependence on the solution of the control algorithm for the vehicle, wherein the control algorithm comprises a model associated with the vehicle, state data indicative of a state of the vehicle, the trajectory data and the one or more constraints; and
output one or more signals indicative of the one or more control input for controlling the vehicle.

15. Computer software which, when executed by a computer, is arranged to perform the method according to claim 14.

16. The control system of claim 2, wherein the one or more processing devices are arranged to determine each of each constraint as a risk value indicative of a risk associated with a proximity of the vehicle to the one or more objects.

17. The control system of claim 4, wherein one or both of the intervention area and the critical area are determined based at least in part on each attribute of the one or more objects.

18. The control system of claim 5, wherein the one or more processing devices are arranged to determine the solution of the control algorithm for the vehicle such that one or more constraints adopt a risk value less than the predetermined risk threshold.

19. The control system of claim 7, wherein the one or more processing devices are arranged to select the closest of the one or more objects in each of a plurality of regions in the vicinity of the vehicle.

20. The control system of claim 9, wherein the classification is indicative of a type of the one or more objects.
